(19) United States
(12) Patent Application Publication
(10) Pub. No.: US 2004/0092220 A1
(43) Pub. Date: May 13, 2004

(54) Tubular net sleeve enclosing an unfilled food casing

(76) Inventor: Goran Rydenfors, Klagerup (SE)

Correspondence Address: BURNS DOANE SWECKER & MATHIS L L P, POST OFFICE BOX 1404, ALEXANDRIA, VA, 22313-1404, US

(21) Appl. No.: 10/471,715

(22) PCT Filed: May 2, 2002
(86) PCT No.: PCT/SE02/00844

(30) Foreign Application Priority Data
Jun. 13, 2001 (SE) 0102090-8

(51) Int. Cl. A22C 11/00

(52) U.S. Cl. 452/32

(57) ABSTRACT

The present invention relates to a tubular net sleeve enclosing unfilled shirred food casings, said tubular net sleeve being sealed at each end, usually by a clip. At least one end of the tubular net sleeve an opening is provided in order to facilitate the availability of the unfilled food casings.

### TECHNICAL FIELD OF THE INVENTION

The present invention relates to a tubular net sleeve enclosing an unfilled shirred food casing, said tubular net sleeve sealed at each end, usually by a clip. The invention also relates to a method for manufacturing said tubular net sleeve.

### TECHNICAL BACKGROUND

Today almost all unfilled food casings are sold to the provision dealer in a tubular shirred form. The tubular shirred food casings are usually held tightly together by an outer net surrounding the casings. The length of the shirred food casings surrounded by the net may vary. The outer net is held together by clips at each end. This is usually the form in which the provision dealer receives the food casings, depending naturally of the food stuffing machinery used by the provision dealer.

When the provision dealer starts his manufacturing he must get access to the shirred casings enclosed by the surrounding net. Therefore, early in the manufacturing process the net or the clip has to be cut opened by the factory hand worker in order to release the food casings. This step reduces the manufacturing speed of the food sausages. Thus, from the point of view of the provision dealer there is an inconvenient step in the manufacturing process, slowing down the number of manufactured food sausages on a time basis.

A further disadvantage with the above used packaged shirred food casings is the cutting step by the factory hand worker, where the fragile food casings may be cut and damaged and cannot be used in the further process. In this case the food casings has to be exchanged for a new one, thus increasing the manufacturing cost.

Another presently used system within the area of provisions is the use of plastic rings at one end of the net sleeve in order to obtain an opening at the end of the net sleeve so that this end can be easily arranged on the stuffing machine. A system like this is described in WO 96/35333. The major disadvantage of this system is that, even though the speed of the manufacturing process is increased by using the plastic ring, the end product is more expensive due to the high cost of the plastic ring. Another disadvantage is that the machinery for shirring the unfilled casings has to be reconstructed. This is naturally also an additional cost.

Thus, there is a need within the art of provisions to speed up the manufacturing process and at the same time avoiding an increase of the costs for the end product.

### SUMMARY OF THE INVENTION

Thus, the object of the present invention is to provide a tubular net sleeve enclosing an unfilled shirred food casing, said tubular net sleeve being sealed at each end, wherein an opening is provided at at least one end of said tubular net sleeve in order to facilitate the availability of the unfilled food casing.

Another object of the present invention is to provide a method of manufacturing above tubular net sleeve, wherein said opening at at least one end of the tubular net sleeve is cut by a sharp-edged tool, for example a knife.

According to one aspect of the invention a tubular net sleeve is provided, wherein said tubular net sleeve is made of plastic, cellulose or natural fibre materials.

The machinery for shirring and enclosing the unfilled food casings with a net has to be supplemented with a sharp-edged tool only at the very last step of the process. This does not require a complete reconstruction of the machinery.

Thus, the present invention has solved above discussed problems by providing a new type of tubular net sleeve enclosing unfilled food casings.

The tubular net sleeve of the invention has the advantage that the factory hand worker filling the food casings can remove the net from the casings in a very easy way, simply by putting his finger in the opening of the net sleeve and tearing off the net sleeve without any additional tools. This does not only speed up the manufacturing process but also save the casings from being damaged by the use of sharp-edged tools during the pressed filling conditions.

1. A tubular net sleeve enclosing an unfilled shirred food casing, said tubular net sleeve being sealed at each end, characterised in that an opening is provided at at least one end of said tubular net sleeve in order to facilitate the availability of the unfilled food casing.

2. A tubular net sleeve according to claim 1, wherein said tubular net sleeve is made of plastic, cellulose or natural fibre materials.

3. A method of manufacturing a tubular net sleeve according to claim 1 or 2, characterised in that an opening at at least one end of the tubular net sleeve is cut by a sharp-edged tool.

4. A method according to claim 3, wherein said sharp-edged tool is a knife.
